(19) United States
(12) Patent Application Publication
(10) Pub. No.: US 2021/0222304 A1
(43) Pub. Date: Jul. 22, 2021

(54) ELECTROLYSIS DEVICE CAPABLE OF PRODUCING STERILIZING AGENT OR DETERGENT, AND ELECTROLYSIS METHOD THEREOF

(71) Applicant: Eun Sang KIM, Wonju-si (KR)

(72) Inventor: Eun Sang KIM, Wonju-si (KR)

(21) Appl. No.: 16/095,719

(22) PCT Filed: Jul. 23, 2018
(86) PCT No.: PCT/KR2018/008261

§ 371 Date: Oct. 23, 2018

(30) Foreign Application Priority Data
Aug. 28, 2017 (KR) 10-2017-0108585

(51) Int. Cl. C25B 1/04; C25B 1/26; C25B 1/18; C25B 5/00; C25B 9/17

(52) U.S. Cl. CPC C25B 1/04; C25B 1/26; C25B 9/17; C25B 5/00; C25B 1/18

(57) ABSTRACT

The present invention relates to a device and method for producing a sterilizing agent or detergent according to an additive. Specifically, the present invention relates to an electrolysis device including an additive vessel in which an additive to be used for electrolysis is put and a non-membrane electrolytic bath in which the electrolysis is performed, and for the electrolysis, water containing chloride ion (Cl—), sodium chloride (NaCl), and an aqueous hydrochloric acid solution are electrolyzed in a non-membrane electrolytic bath.

### BACKGROUND OF THE INVENTION

### 1. Technical Field

The present invention relates to an electrolysis device capable of producing a sterilizing agent or detergent, and an electrolysis method thereof, and more particularly to a device and method for producing a germicide or detergent based on an additive added to electrolysis.

### 2. Description of Related Art

Sterilization is a process of physically and chemically stimulating microorganisms to kill them in a short period of time. The sterilization distinguishes between sterilization for a completely aseptic state and disinfection for an almost aseptic state depending on the extent.

The sterilization is caused by mechanical disruption of bacteria, strong denaturation of a protein, inactivation of an enzyme, and the like, and may be performed by using physical or chemical methods. Physical sterilization provides a physically environment in which bacteria are sterilized using dry, sunlight, ultraviolet rays, radiation methods, and the like to the target. Chemical sterilization provides a chemical environment in which bacteria is sterilized using a sterilizing agent, a sterilizing gas, and the like.

The sterilization is mainly to remove harmful bacteria that harm the human body, and in the case of food, it is removed by washing.

If harmful bacteria remain, it may cause food poisoning, waterborne diseases and the like. Specifically, bacteria that cause waterborne diseases and bacteria that cause food poisoning are left in tableware, food processing apparatus, cookware, food factory manufacturing equipment, and group feeding facilities, resulting in food poisoning or waterborne diseases. Therefore, in order to prevent food poisoning and waterborne diseases, it is necessary to destroy the bacteria in food utensils, food processing apparatuses, cooking utensils, food factory manufacturing equipment, and group feeding facilities. Although this sterilization is mainly performed by using a physical or chemical method, there are problems in that it requires an apparatus and equipment for sterilization and takes a long time.

Accordingly, in recent years, washing water which can easily wash various cooking facilities has been replaced with sterilizing water, and sterilization is performed at the same time as washing, thereby increasing a sterilization efficiency. In the case of food, since sterilization and disinfection are necessary in order to secure safety, a sterilizing disinfectant is currently designated as a subject to be controlled by the Food Sanitation Act.

A chlorine (Cl₂) disinfection method is used for sterilization of tap water which is routinely supplied and used for washing. Chlorine sterilizes or inactivates microorganisms by altering the permeability of microbial cell membranes. Chlorine disinfection is widely used as a water disinfectant because of its excellent persistence and economy of disinfection function.

However, it has been known that trihalomethane (THM), which is a carcinogen, is produced by the reaction of chlorine with an organic compound of raw water disinfected with chlorine. In particular, the amount of trihalomethane increases as the amount of chlorine supplied increases. In addition, chlorine has a characteristic odor and remains after disinfection. Therefore, the amount of chlorine used for disinfection is being reduced in order to suppress odor while minimizing the generation of carcinogen.

As a result, the use of chlorine reduces the disinfection effect and reduces the residual amount of chlorine, which increases the risk of contamination of the remaining bacteria in the pipe during transport of the water instead of being sterilized. Therefore, a sterilized water containing a sterilizing material is used in order to increase the sterilizing effect. The sterilized water disinfects bacteria in cookware used in contaminated materials or foods and food materials and sterilizes bacteria that cause food poisoning or waterborne diseases in order to improve the stability.

Conventional sterilized water uses a sterilization method using sodium hypochlorite. The sodium hypochlorite, which serves as a sterilizing agent to kill food spoilage bacteria and pathogens, is used for beverages, vegetables and fruits, containers, utensils, tableware, and the like. The sodium hypochlorite dissolves well in water, and an aqueous solution decomposes during storage and generates chlorine gas, so if stored for a long period, it becomes ineffective as a sterilizing agent. A sterilizing power is influenced by a hydrogen ion concentration (pH) and the effective chlorine amount, and the sterilization power is stronger as hydrogen ions are in an undissociated state and the hydrogen ion concentration (pH) is lower.

A sodium hypochlorite disinfection method includes a method of injecting commercially available sodium hypochlorite (NaOCl) and a method of directly generating it by electrolysis in the field. A large amount of sodium hypochlorite must be used in order to increase the sterilizing power, whereby facilities for producing sterilized water are increased in size. The sterilized water produced by large production equipment can reduce the production cost by producing a larger amount of sterilized water in a single operation. Therefore, there was a need for a device for storing and transporting the sterilized water produced in large quantities.

In order to solve such a problem, a sterilizing apparatus (U.S. Pat. No. 789,325 and US Patent Application Publication No. 2004-013707) using hypochlorous acid which is produced in a small amount during electrolysis for producing sodium hypochlorite and has a high sterilizing power is used.

Hypochlorous acid (HOCL) is produced together with hydrogen (H) and hypochlorite ion (OCL-) in the electrolysis process for producing sodium hypochlorite (NaOCL). The hypochlorous acid has about 70 times more sterilizing power than sodium hypochlorite. In addition, the hypochlorous acid has a great difference in sterilization power according to the hydrogen ion concentration (pH), and has a maximum sterilizing power when the hydrogen ion concentration (pH) is in a range of 4.3 to 5.9.

Therefore, when sterilized water is produced using the hypochlorous acid, the sterilizing water having a high sterilizing power is produced with a small amount of hypochlorous acid, and thus the size of a sterilized water producing apparatus is reduced, and the small amount of sterilized water may be easily produced and may be manufactured without devices for movement and storage.

However, since the hypochlorous acid is not only produced in a small amount but also mixed with a large amount of sodium hypochlorite, it is difficult to separate the hypochlorous acid.

In addition, the hypochlorous acid has a large difference in the sterilizing power depending on the hydrogen ion concentration. That is, when the hydrogen ion concentration is out of a range of 4.3 to 5.9 which has a maximum sterilizing power, the sterilizing power may be reduced such that it may not be used to be unsuitable for the sterilized water.

Accordingly, a study on a method capable of directly producing hypochlorous acid in a place such as a house using the sterilizing agent, adjusting the hydrogen ion concentration (pH) to a range that can achieve a maximum sterilizing power, and producing it by separating it from the sodium hypochlorite, is required.

The above information disclosed in this Background section is only for enhancement of understanding of the background of the invention and therefore it may contain information that does not form the prior art that is already known in this country to a person of ordinary skill in the art.

### SUMMARY OF THE INVENTION

An object of the present invention is to solve the aforementioned problems and other problems. Another object of the present invention is to provide a device and a method for producing a sterilizing agent or detergent.

Technical objects desired to be achieved in the present invention are not limited to the aforementioned objects, and other technical objects not described above will be apparent to those skilled in the art from the disclosure of the present invention.

For achieving the objects or other objects, an aspect of the present invention provides an electrolysis device including an additive vessel in which an additive to be used for electrolysis is put and a non-membrane electrolytic bath in which the electrolysis is performed, and for the electrolysis, water containing chloride ion (Cl—), sodium chloride (NaCl), and an aqueous hydrochloric acid solution are electrolyzed in a non-membrane electrolytic bath.

### Advantageous Effects

Effects of the effect of the electrolysis device and method according to the exemplary embodiment of the present invention will be described as follows.

According to at least one of the exemplary embodiments of the present invention, hypochlorous acid can be directly produced at home.

Further, according to at least one of the exemplary embodiments of the present invention, there is a merit that various kinds of additives used in electrolysis can be individually or accurately mixed and used as an additive.

The additional range of applicability of the present invention will become apparent from the following detailed description. However, since various modifications and alternations within the spirit and scope of the present invention may be clearly understood by those skilled in the art, it is to be understood that a detailed description and a specific exemplary embodiment of the present invention such as an exemplary embodiment of the present invention are provided only by way of example.

### BRIEF DESCRIPTION OF THE DRAWINGS

FIG. 1 illustrates a conceptual diagram of an electrolysis device 101 according to an exemplary embodiment of the present invention.

FIG. 2 illustrates a flowchart of an electrolysis method according to an exemplary embodiment of the present invention.

FIG. 3 is a cross-sectional configuration diagram illustrating a measuring vessel according to an exemplary embodiment of the present invention, and FIG. 4 is a partial cross-sectional configuration diagram illustrating a measuring cup according to an exemplary embodiment of the present invention.

FIG. 5 is an enlarged side view of a measuring cup according to another exemplary embodiment of the present invention.

FIG. 6 is a detailed cross-sectional view illustrating an area A of FIG. 5.

### DETAILED DESCRIPTION OF THE INVENTION

Hereinafter, exemplary embodiments disclosed in the present specification will be described in detail with reference to the accompanying drawings. In the present specification, the same or similar components will be denoted by the same or similar reference numerals, and a repeated description thereof will be omitted. Terms “module” and “unit” for components used in the following description are used only in order to easily make a specification. Therefore, these terms do not have meanings or roles that distinguish them from each other in themselves. In describing exemplary embodiments of the present specification, when it is determined that a detailed description of the well-known art associated with the present invention may obscure the gist of the present invention, it will be omitted. The accompanying drawings are provided only in order to allow exemplary embodiments disclosed in the present specification to be easily understood and are not to be interpreted as limiting the spirit disclosed in the present specification, and it is to be understood that the present invention includes all modifications, equivalents, and substitutions without departing from the scope and spirit of the present invention.

Terms including ordinal numbers such as first, second, and the like will be used only to describe various components, and are not to be interpreted as limiting these components. The terms are only used to differentiate one component from other components.

It is to be understood that when one component is referred to as being “connected” or “coupled” to another component, it may be connected or coupled directly to the other component or be connected or coupled to the other component with a further component intervening therebetween. On the other hand, it is to be understood that when one component is referred to as being “connected or coupled directly” to another component, it may be connected to or coupled to the other component without another component intervening therebetween.

Singular forms are to include plural forms unless the context clearly indicates otherwise.

It will be further understood that terms “comprises” or “have” used in the present specification specify the presence of stated features, numerals, steps, operations, components, parts, or a combination thereof, but do not preclude the presence or addition of one or more other features, numerals, steps, operations, components, parts, or a combination thereof.

Sodium Hypochlorite is a colorless or pale greenish-yellow liquid with a chlorine odor. A chemical formula thereof is NaClO. The sodium hypochlorite dissolves well in water, and an aqueous solution decomposes during storage and generates chlorine gas, so if stored for a long period, it becomes ineffective as a sterilizing agent. The sterilizing power is influenced by a hydrogen ion concentration (pH) and the effective chlorine amount, the sterilization power is stronger as hydrogen ions are in an undissociated state and the hydrogen ion concentration (pH) is lower, and the sterilizing power is decreased by amino acid, protein, sugar, and the like. The sodium hypochlorite diluted to a concentration of 100 ppm is adjusted to 8 to 9 pH, which has a greatest sterilizing power. It is highly corrosive and should not be contacted with metal containers, and when used for disinfecting dishes, it must be used after washing dishes, to accomplish a high sterilizing power. It is stored in a shaded glass container.

Hypochlorous acid (HClO) is used as a disinfectant in water, fruit, tableware, tofu and so on. The hypochlorous acid may be made by distilling a bleaching powder in a carbon dioxide stream, shaking a carbon tetrachloride solution of chlorine dioxide together with water, or by using an aqueous solution of sodium hydrogen carbonate (sodium bicarbonate) at a low temperature through chlorine gas. A concentrated solution with a maximum concentration of 25% is greenish yellow, and the diluted solution is colorless and has an irritating smell similar to a whitening agent. It is a weaker acid than acetic acid, and its aqueous solution is unstable, decomposes by releasing oxygen, and produces hydrochloric acid and chloric acid to exhibit strong oxidation activity. If stored at −20° C., it can be stored for several days, but storage at room temperature is not as easy as sodium hypochlorite.

Hypochlorous acid (HOCL) is produced together with hydrogen (H) and hypochlorite ion (OCL-) in the electrolysis process for producing sodium hypochlorite (NaOCL). The hypochlorous acid has about 70 times more sterilizing power than sodium hypochlorite. In addition, the hypochlorous acid has a great difference in sterilization power according to the hydrogen ion concentration (pH), and has a maximum sterilizing power when the hydrogen ion concentration (pH) is in a range of 4.3 to 5.9.

In the present exemplary embodiment, it is proposed to easily produce chlorate at home through electrolysis and to use it immediately. Even if it is not easy to store hypochlorous acid, it will be able to be used immediately.

Further, in an exemplary embodiment of the present invention, it is proposed to produce hypochlorous acid or sodium hypochlorite, which is a sterilizing agent, or potassium hydroxide as a detergent, depending on a kind of an additive added to the electrolytic device.

For this purpose, in an embodiment of the present invention, a non-diaphragm electrolytic bath including an electrode may be provided, and water containing chloride ion (Cl—), sodium chloride (NaCl), and an aqueous hydrochloric acid solution may be may be electrolyzed in the non-diaphragm electrolytic bath.

In addition, in an embodiment of the present invention, an additive container for adding an additive to the electrolysis may be further provided.

The additive container will be described later in detail.

In an exemplary embodiment of the present invention, an optional product may be obtained according to a type of the additive, and an experimental result thereof is attached as follows.

### Experimental Method 1

1) An additive was added to 500 ml of raw water (tap water)(water containing chloride ion), and after non-membrane electrolysis was performed for about 5 minutes, the pH of the product was measured.

2) The additive was subjected to multiple sequential experiments with different ratios of 30% salt water (NaCl) and hydrochloric acid (HCl).

TABLE 1

| | pH value of product according to ratio of ‘salt | | | | |
|---|---|---|---|---|---|
| | water:hydrochloric acid solution ratio’ of additive | | | | |
| | Ratio | | | | |
| | 2:1 | | 4:1 | 1:1 | |
| | 5 ml:2.5 | 4 ml:2 | 5 ml:1.25 | 3 ml:3 | 2 ml:2 |
| | ml | ml | ml | ml | ml |
| 1^{st} round | 3.37 | 5.37 | 3.93 | 2.95 | 2.96 |
| 2^{nd} round | 3.36 | 4.30 | 4.52 | 2.46 | 3.01 |
| 3^{rd} round | 3.67 | 5.06 | 4.01 | 2.56 | 2.75 |
| 4^{rd} round | 3.33 | 5.12 | 4.83 | 2.85 | 3.52 |
| 5^{rd} round | 3.48 | 5.62 | 3.89 | 2.48 | 3.12 |
| 6^{rd} round | 3.63 | 5.83 | 4.12 | 2.49 | 3.48 |

### Experimental Method 2

1) An additive was added to different amounts (500 ml and 1000 ml) of raw water (tap water)(water containing chloride ion), and after non-membrane electrolysis was performed for about 5 minutes, the pH of the product was measured.

2) The additive was subjected to multiple sequential experiments with a ratio of 30% salt water (NaCl) and hydrochloric acid (HCl) prepared at 1:1 (2 ml:2 ml)

TABLE 2
pH value of product according to amount of raw water

Amount of raw water

| | 500 ml | 1000 ml |
|---|---|---|
| 1^{st} round | 3.41 | 5.82 |
| 2^{nd} round | 3.56 | 5.76 |
| 3^{rd} round | 3.45 | 5.55 |
| 4^{rd} round | 3.85 | 5.01 |
| 5^{rd} round | 5.58 | 5.80 |
| 6^{rd} round | 5.97 | 5.67 |

### Experimental Method 3

1) An additive was added to 500 ml of raw water (tap water)(water containing chloride ion), and after non-membrane electrolysis was performed for about 5 minutes, the pH of the product was measured.

2) The additive was subjected to multiple sequential experiments with different amounts of an aqueous potassium carbonate (K₂CO₃) solution.

TABLE 3
pH value of product according to amount
of aqueous potassium carbonate solution

| | Amount of aqueous potassium | | |
|---|---|---|---|
| | carbonate solution | | |
| | 2 ml | 4 ml | 6 ml |
| 1^{st} round | 10.78 | 10.93 | 11.04 |
| 2^{nd} round | 10.70 | 10.90 | 11.01 |
| 3^{rd} round | 10.69 | 10.94 | 11.02 |
| 4^{rd} round | 10.65 | 10.95 | 11.02 |
| 5^{rd} round | 10.68 | 10.91 | 11.06 |
| 6^{rd} round | 10.60 | 10.91 | 11.05 |

Hypochlorous acid water (HOCl) was produced as a product as a result of Experimental Methods 1 and 2, and potassium hydroxide (KOH) was produced as a product as a result of Experimental Method 3.

According to Experimental Methods 1 and 2, following reactions are performed at (+) and (−) electrodes, producing hypochlorous acid.

(+) electrode

HCl→H++Cl−

2Cl−→Cl₂+2e−

C2l+H2O→HOCl (hypochlorous acid)+HCl

(−) electrode

HCl→H++Cl−

2H++2e−→H₂

It is obvious that hypochlorous acid water can be used as a sterilizing agent having an extremely high sterilizing power as described above, and potassium hydroxide can be used for various purposes as a natural detergent.

Therefore, in the present invention, it is proposed to a device and method for producing a detergent or sterilizing agent based on the above experimental results.

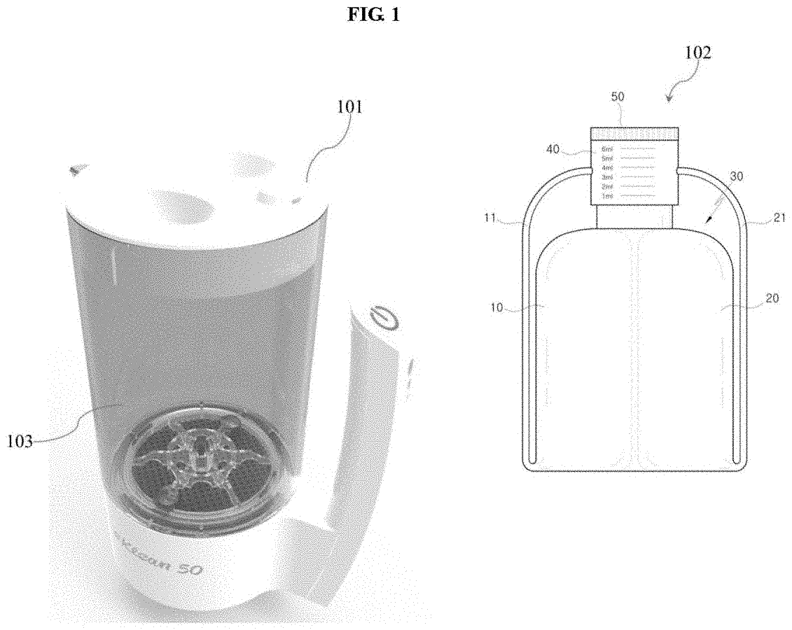

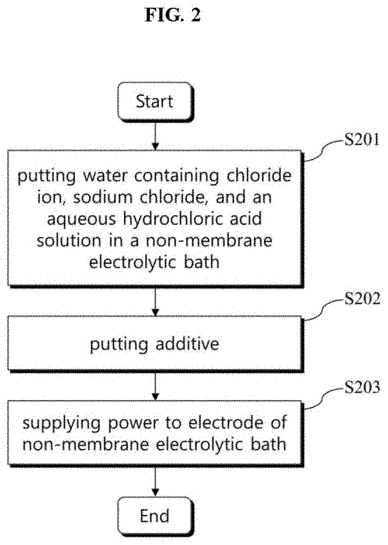

FIG. 1 illustrates a conceptual diagram of an electrolysis device 101 according to an exemplary embodiment of the present invention. FIG. 2 illustrates a flowchart of an electrolysis method according to an exemplary embodiment of the present invention.

In an exemplary embodiment of the present invention, the electrolysis device 101 may include a non-membrane electrolytic bath 103 and a vessel 102.

A vessel body 30 molded from a synthetic resin material is provided integrally with a first liquid storage 10 and a second liquid storage 20, and a measuring cup 40 having a capacity gradation displayed on a side wall thereof is provided at an upper portion of the vessel body 30. Pumping tubes 11 and 21 are connected at opposite sides of the vessel body 30 to pump a material stored in the first storage 10 and the second storage 20 by using the measuring cup 40, and an openable cap 50 is detachably mounted on an upper portion of the measuring cup 40 in a screw-interlocking manner.

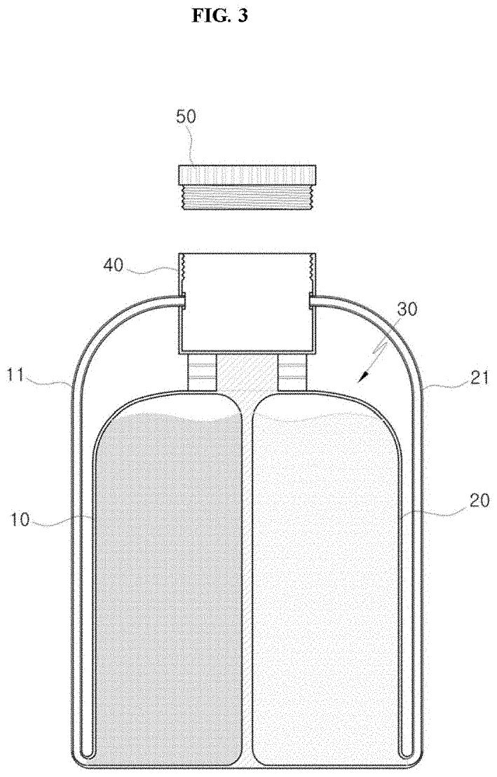

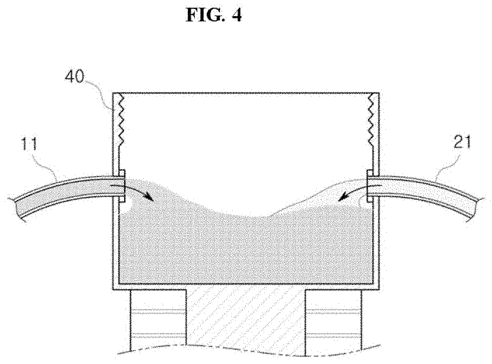

FIG. 3 is a cross-sectional configuration diagram illustrating a measuring vessel according to an exemplary embodiment of the present invention, and FIG. 4 is a partial cross-sectional configuration diagram illustrating a measuring cup according to an exemplary embodiment of the present invention.

In the measuring vessel according to the present exemplary embodiment, different materials may be respectively stored in the first liquid storage 10 and the second liquid storage 20.

In other words, in the electrolysis device 101 according to the present exemplary embodiment, since different products may be generated according to a type of the additive, different additives may be put in the first storage 10 and the second storage of the vessel 20. Table 4 below shows an example of an additive that can be stored in the vessel 102 according to an exemplary embodiment of the present invention.

TABLE 4

| | First additive of | Second additive of |
|---|---|---|
| | first storage 10 | second storage 20 |
| First example | Salt water (15%) | Aqueous hydrochloric |
| | | acid solution (2.5%) |
| Second example | Salt water (15%) | Aqueous citric acid |
| | | solution (150 ml + 30 g) |
| Third example | Salt water (15%) + | Aqueous potassium |
| | aqueous hydrochloric | hydroxide solution |
| | acid solution (2.5%) | |
| Fourth example | Salt water (15%) + | Aqueous potassium |
| | aqueous hydrochloric | hydroxide solution |
| | acid solution | |
| Fifth example | Salt water (15%) | Vinegar |

When different additives are stored in the storages 10 and 20 according to the first to fourth examples, a user may not only put selectively a desired additive but also mix two additives at an accurate ratio and put it into the electrolysis.

According to an exemplary embodiment of the present invention, the mixing ratio of the additives is important. This is because a desired degree of pH may be different for each user. For example, when a user thinks that a low-pH sterilizing agent is effective and meets his or her usage criterion, the amount of the second additive stored in the second storage 20 in the first or second example may be increased.

Even when the pH is to be changed according to usage purposes, it may be necessary to appropriately change the mixing ratio of the additives. For example, in the case of toilet sterilization, it may be possible to mix the additives to lower the pH for stronger sterilizing power. On the contrary, when it is applied to a human body such as a wound, it is necessary to mix the additives so as to obtain an effective pH close to neutrality.

As such, when a user intends to apply additives by modifying them according to various situations such as usage purposes and skin types, the user can easily add the additives by accurately metering the additives that are individually stored in the first and second storages 10 and 20 of the vessel 102 according to an exemplary embodiment of the present invention.

A first additive is pumped through the pumping tube 11 to be contained in the measuring cup 40 by a predetermined amount when the first storage 10 is pressed and pushed. Although each of the additives may be used individually or independently, a second additive may be pumped by pressing the second storage 20 so that the first and second additives may be used in a mixed state at a certain ratio.

In other words, according to an exemplary embodiment of the present invention, the vessel 50 capable of discharging and metering can store various kinds of materials at the same time, and can selectively use only a specific material or use a mixture of two or more materials at a predetermined ratio, thereby maximizing the usability of the product.

In addition, as in the third and fourth examples, when hydroxide potassium is used as the second additive stored in the second storage 20, it may be possible to selectively produce a sterilizing agent and a detergent, as shown in the first to third experiments.

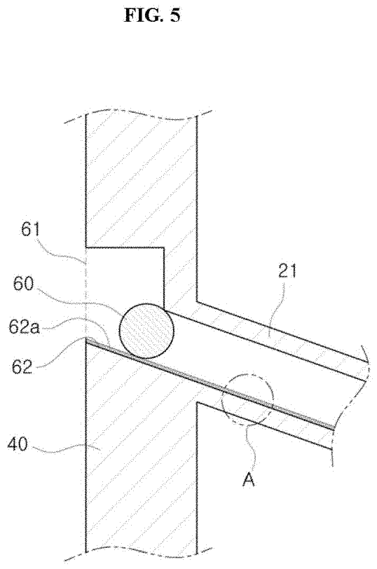

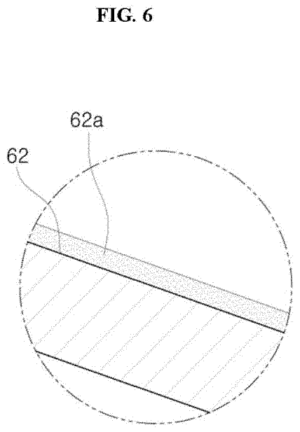

On the other hand, FIG. 5 and FIG. 6 illustrate a backflow preventing structure according to another exemplary embodiment of the present invention. A backflow preventing ball 60 is provided at a connection portion with the pumping tubes 11 and 21 in the measuring cup 40. A fine mesh 61 is provided on the sidewall of the measuring cup 40 to prevent the overflow preventing ball 60 from escaping and prevent inflow of foreign matter. An inclined surface 62 is formed downwardly directed to the pumping tubes 11 and 21 such that the backflow preventing ball 60 maintains a contact state with outlet portions of the measuring tubes 11 and 21 at the connection portion with the pumping tubes 11 and 21.

A lubricating layer 62a is coated on the inclined surface 62 so as to prevent adherence of the backflow preventing ball 60 and to prevent foreign matter from being adsorbed, and the lubricating layer 62a may have a mixed composition of 20 to 40 wt % of Teflon, 10 to 30 wt % of nano silver, 10 to 20 wt % of methyl methacrylate (MMA), 10 to 20 wt % of silica glass, 5 to 10 wt % of unsaturated polyester resin, and 1 to 5 wt % of oyster shell fine powder.

In this case, the backflow preventing ball 60 normally blocks inlet portions of the pumping tubes 11 and 21 by the inclined surface 62, and is opened only by a pressure action in pumping.

Accordingly, it is possible to prevent a liquid mixed in the measuring cup 40 from backflowing through the pumping tubes 11 and 21 by the backflow preventing ball 60 in a discharging process.

In the meantime, since the lubricating layer 62a is formed on the inclined surface 62, the flow of the backflow preventing ball 60 may be smoothly performed, thereby ameliorating a problem caused by the material adhesion. In particular, since the oyster shell fine powder, methyl methacrylate and silica glass are added together, durability of the lubricating layer 62a may be increased to prevent crack generation of the lubricating layer 62a due to the contact of the backflow preventing ball 60.

In addition, the unsaturated polyester resin increases a bonding force between the oyster shell powder and the silica glass, thereby preventing the lubricating layer 62a from falling off.

Referring to FIG. 2, in the electrolysis method according to an exemplary embodiment of the present invention, chlorideion-containing water, chloridesodium and aqueous hydrochloric acid solution may be put in the non-membrane electrolysis bath 103 (step S201).

Then, the additives described above may be put (step S202). A product by electrolysis and a pH value of the product may vary depending on the additive, as described above.

In step S203, electrolysis may be performed by supplying electric power to the electrode of the electrolytic bath 103.

Although explaining the electrolysis method and the electrolysis device using the same according to the present invention which will be described by way of at least one exemplary embodiment, whereby the technical concept and the construction and operation of the present invention as not to be limited, to not to be limited/restricted by the description in the range of the technical concept of the present invention with reference to the drawings or figures. The concepts and embodiments of the invention presented herein may be used by those of ordinary skill in the art as a basis for modifying or designing a different structure to carry out the same purposes of this invention, and the present invention generally modified or changed equivalent structures by those having knowledge in the art belonging to the as being bound by the technical scope of the present invention described in the claims, the spirit and scope of the invention described in the claims various changes within the limits that do not depart, may be substituted and changed.

1. An electrolysis device comprising:
an additive vessel configured to put an additive for electrolysis; and
an electrolytic bath in which the electrolysis is performed,
wherein, for the electrolysis, the water containing chlorideion (Cl—), chloridesodium (NaCl) and aqueous hydrochloric acid solution (HCl) is put in a non-membrane electrolytic bath.

2. The electrolysis device of claim 1, wherein, for the electrolysis, a pH value of an electrolysis product varies according to the additive.

3. The electrolysis device of claim 1, wherein, for the electrolysis, according to the additive, hypochlorous acid (HOCl) is produced, or hydroxide potassium (KOH) is produced.

4. An electrolysis method for selectively producing a sterilizing agent or detergent using electrolysis, the electrolysis method comprising:
putting water containing chloride ion (Cl—), sodium chloride (NaCl), and an aqueous hydrochloric acid solution in a non-membrane electrolytic bath;
putting an additive; and
supplying electric power to the electrode provided in the non-membrane electrolytic bath,
wherein a pH value of an electrolysis product varies according to the additive.

5. The electrolysis method of claim 4, wherein, for the electrolysis, according to the additive, hypochlorous acid (HOCl) is produced, or hydroxide potassium (KOH) is produced.
